(19) United States
(12) Patent Application Publication
(10) Pub. No.: US 2011/0051269 A1
(43) Pub. Date: Mar. 3, 2011

(54) TRUE SAFE MIRRORS

(76) Inventor: RICHARD HIGNIGHT, Fort Worth, TX (US)

(21) Appl. No.: 12/875,122

(22) Filed: Sep. 2, 2010

Related U.S. Application Data
(60) Provisional application No. 61/239,083, filed on Sep. 2, 2009.

(51) Int. Cl. G02B 5/08

(52) U.S. Cl. 359/850

(57) ABSTRACT

A true safe mirror is provided for a motor vehicle. The true safe mirror is a wedge shaped member which has an approximate two to three degree (2°-3°) angle to increase the vision of a driver. The mirror can be attached to an existing motor vehicle mirror, thereby providing a better field of visibility to eliminate blind spots. The true safe mirror gives the driver a wider and more accurate view of surrounding objects without any distortion. The mirror can also be a plate shaped member having a front reflective surface. The plate shaped member is encased within a housing carried by the motor vehicle. The plate shaped member has a first portion bent outwardly at a slight angle with respect to a second portion of the plate shaped member to help increase the vision of the driver of the motor vehicle to eliminate blind spots.

### CROSS-REFERENCE TO RELATED APPLICATION

This application claims the benefit of Provisional Patent Application No. 61/239,083, filed on Sep. 2, 2009, in the United States Patent & Trademark Office, the disclosure of which is incorporated herein by reference.

### BACKGROUND OF THE INVENTION

1. Field of the Invention

The present invention relates to a mirror, and more particularly, a true safe mirror for a motor vehicle. The true safe mirror is at an approximate two to three degree)(2°-3°) angle to increase the vision of a driver. The present invention can be attached to or replaced in an existing motor vehicle mirror, thereby providing a better field of visibility to eliminate blind spots. The true safe mirror gives the driver a wider and more accurate view of surrounding objects without any distortion. Approaching motor vehicles are often much closer than they appear in a rearview mirror or in a side view mirror. This is a safety hazard that is often overlooked. The true safe mirror allows the driver to see directly beside their own motor vehicle, as well as other motor vehicles without blind spots. The present invention promotes safety and can effectively assist in reducing accidents and injuries. The true safe mirror can be installed on motor vehicles, such as cars, trucks, buses, SUVs, and more. The present invention can be fitted to any existing motor vehicle mirror or manufactured directly on new models.

2. Description of the Prior Art

It is required that motor vehicles on the road have mirrors to assist the driver with visibility. Drivers use these mirrors when merging onto a highway, changing lanes, parking, and more. The mirrors that are currently installed on motor vehicles have several drawbacks. The main problem is that mirrors create a blind spot for the driver, preventing them from seeing objects, such as other motor vehicles and people, which may be in close proximity. This can cause accidents, resulting in injuries and fatalities. The True Safe Mirrors are not convex mirrors which give distorted images and incorrect distance. The prior art convex mirrors does not give you the true distance of where the other vehicle might be. One good example of this is the passenger side mirror that we presently have on every car made. The convex mirror shows that a car is way back from you when the truth is it is right there on your bumper. Meanwhile, the True Safe Mirrors will show the correct distance of where an object is located. Another issue with the mirrors is that they do not allow the driver to see the side of their motor vehicle, which is often necessary when parking. A more versatile type of mirror is needed.

Numerous innovations for wide range mirrors have been provided in the prior art that will be described. Even though these innovations may be suitable for the specific individual purposes to which they address, however, they differ from the present invention.

A FIRST EXAMPLE, U.S. Patent Office Document No. 4,331,382, Issued on May 25, 1982, to Graff teaches an improved rear view or rear vision mirror for passenger automobiles, vans and like vehicles, exclusive of buses or trucks larger than pick-up trucks, which mirror affords a wide-angle view well beyond the statutory requirement that outside mirrors give a view of the side of the vehicle through a 10 degree angle beyond such side of the vehicle to the extent that the image covers the so-called “blind spot” beyond the 10 degree view path. The improved mirror avoids the use of spherical reflective surfaces and consists essentially of a single substantially planar reflective surface and a single contoured reflective surface that is a generally convex cylindrically contoured surface having a radius of curvature within a critical range of values.

A SECOND EXAMPLE, U.S. Patent Office Document No. 4,575,202, Issued on Mar. 11, 1986, to McGuire teaches a rearview mirror apparatus for automobiles that eliminates the blind spots to the left rear and to the right rear of the automobile comprising a housing holding a mirror having a center mirror portion which is flat so as to reflect images of vehicles located directly behind the driver of the automobile, a left mirror portion which is curved toward the housing so as to reflect images of vehicles located in the left blind spot, and a right mirror portion which is curved so as to reflect images of vehicles located in the right blind spot. The rearview mirror may be mounted on an existing rearview mirror or may replace it.

A THIRD EXAMPLE, U.S. Patent Office Publication No. 2002/0113876, Published on Aug. 22, 2002, to Kim teaches a vehicle surveillance system comprising a plurality of digital cameras mounted on a vehicles's interior and exterior for photographing the dashboard, the interior environment of the vehicle and exterior views around the vehicle to eliminate blind spots inherent to the vehicle's mirrors. A monitor mounted on a front panel of the vehicle displays photographed images. A removable image memory saves the photographed image information. A sound memory stores a plurality of predetermined sounds, including voice sounds, a sound detector detects sounds in close proximity to the vehicle, a sound analyzer compares a detected sound to the sounds stored in the sound memory; and an alarm generator generates an audible alarm through a speaker to the exterior of the vehicle when the sound analyzer determines the detected sound corresponds to one of the stored sounds.

A FOURTH EXAMPLE, U.S. Patent Office Publication No. 2003/0147164, Published on Aug. 7, 2003, to Chan teaches a rearview mirror apparatus consisting of wide range rearview mirror having cover, holder and hanger for providing a full rearview for vehicle drivers.

A FIFTH EXAMPLE, U.S. Patent Office Publication No. 2005/0134982, Published on Jun. 23, 2005, to Stonecypher teaches an apparatus for reflecting to an observer images of objects in a rearward, adjacent blind spot area. The apparatus comprises a mirror so designed as to provide a true reflection of horizontal width size of the objects, a true reflection of horizontal position of the objects, and a wide angle vertical reflection of the objects. The apparatus provides additional safety by covering the blind spot area, and requiring minimal head turning. The apparatus has use in vehicles upon the roadways and waterways.

A SIXTH EXAMPLE, U.S. Patent Office Document No. 6,954,152, Issued on Oct. 11, 2005, to Matthews teaches a side view mirror and camera assembly for providing a mirror combined with a camera directed towards the blind spot of the mirror to allow a driver of a vehicle to view objects near the vehicle that are not viewable using the side view mirror alone. The side view mirror and camera assembly includes an adjustable camera coupled to a side view mirror housing to show a view of the blind spot of the side view mirror on a display viewable by a driver of a vehicle. In an embodiment, the camera is positioned within the side view mirror housing behind a one way portion viewing of the mirror.

A SEVENTH EXAMPLE, U.S. Patent Office Publication No. 2006/0279863, Published on Dec. 14, 2006, to Starbuck teaches a rearward viewing mirror attached to a vehicle configured to increase the viewing area generally rearward of the vehicle, in particular, the driver's blind spot. The rearward viewing mirror includes a reflective surface configured to provide an image of objects rearward of the vehicle. The reflective surface further includes a first section and a second section that are configured in a non-parallel manner. An intersecting angle between the first section and the second section is formed within the range of nine to thirteen degrees. The second section is positioned proximate the vehicle such that the rearward viewing mirror provides increased viewing of objects proximate the driver's blind spot while inhibiting distortion thereof.

AN EIGHTH EXAMPLE, U.S. Patent Office Publication No. 2007/0058276, Published on Mar. 15, 2007, to Behbehani teaches an alignment system for side view mirrors featuring a mirror with regions of diverse curvature, with an upright alignment line in a region of greater curvature. The side view mirror is set up so that the side of a user's vehicle lies entirely on the side of the alignment line closest to the vehicle. This generates a cone of vision to the rear of the vehicle which overlaps with the cone of vision from a rear view mirror such that blind spots are greatly reduced or eliminated.

A NINTH EXAMPLE, U.S. Patent Office Document No. 7,234,825, Issued on Jun. 26, 2007, to Meng teaches a curved rearview mirror system for vehicles which allows a driver to see the entire area of a driver's blind spot from looking into any one of three mirrors without giving the driver an overly distorted view. The mirror system includes a central rearview mirror with a central planar section and two side convexly curved sections having a constant radius of curvature. The mirror system also includes left and right side rearview mirrors. Each side rearview mirror includes a central planar section, a convexly curved side section, a convexly curved top section, and a convexly curved bottom section. The shape and placement of each mirror is governed by a series of equations that give the driver the best possible view of the blind spot.

A TENTH EXAMPLE, U.S. Patent Office Publication No. 2007/0188896, Published on Aug. 16, 2007, to Lee teaches an adjustable rear view mirror structure. The rear view mirror structure comprises a flexible body and an adjusting apparatus wherein the body has a reflective surface and an inner surface. The adjusting apparatus is disposed at a rear portion of the body and is utilized to drive the inner surface of the body. Thus, the reflective surface of the body can form a particular curvature whereby the rear view mirror structure can offer a wider viewing angle.

AN ELEVENTH EXAMPLE, U.S. Patent Office Document No. 7,423,521, Issued on Sep. 9, 2008, to Kukita et al. teaches a vehicular visual assistance system, an image picked up by an image pickup device is processed by an image processing device, and displayed on a display monitor. The image pickup device is mounted on a lower part of a door mirror housing, and is capable of picking up an image of a region that is continuous in the fore-and-aft direction. The imaged region includes part of a front region directly viewed by a vehicle driver, and part of a rear region indirectly viewed by the vehicle driver via a door mirror. The image processing device displays, on the display monitor, an imaged region for which at least front and rear boundaries thereof of the viewed regions overlap. Thus, it is possible to avoid a blind spot from occurring between the direct and indirect views and the image based on the picked up image, thereby improving visibility.

A TWELFTH EXAMPLE, U.S. Patent Office Publication No. 2008/0231981, Published on Sep. 25, 2008, to Wada teaches a partial curved on-vehicle rear view mirror, wherein a center main portion is formed in a flat surface, but an outer portion is formed in a gentle convex surface toward the outside, a lower portion is also formed in a gentle convex surface toward the lower side, and an inner portion is also formed in a convex surface toward the inside so that the view of the mirror can be safely and efficiently increased in each direction. Since the center main portion is formed in the flat surface, the safety of the operations of automobiles, motorcycles, and so on can be sufficiently increased by sufficiently expanding the rear view to the sides and also expanding the view in the lower side while sufficiently securing visual stability.

A THIRTEENTH EXAMPLE, U.S. Patent Office Publication No. 2008/0285157, Published on Nov. 20, 2008, to Goraguer teaches a motor vehicle rearview mirror for producing an image of an object situated outside and behind the vehicle, the rearview mirror comprising a lens and a mirror and being characterized in that the lens is a diverging concave lens having an optical axis and an optical focus, and the mirror is a mirror that is substantially concave, light beams passing through the diverging lens towards the mirror that reflects them in converging manner substantially without optical distortion in a direction that corresponds to the viewing axis of the driver looking at the mirror, characterized in that the mirror defines a concave reflective surface that corresponds substantially to a segment of a cylinder.

A FOURTEENTH EXAMPLE, U.S. Patent Office Document No. 7,520,616, Issued on Apr. 21, 2009, to Ooba teaches a vehicular visual assistance system that includes: a retro-reflective surface formed on an inside face of a pillar that is in a position obstructing the view of a vehicle driver seated on a driver's seat within a vehicle compartment; a camera mounted on the vehicle outside the vehicle compartment for taking an image outward from the pillar in a direction that is substantially the same as the line of vision of the vehicle driver on the driver's seat; and a projector for projecting in real time the image taken by the camera toward the retro-reflective surface of the pillar. The projector is fixedly disposed within the vehicle compartment at a position close to the eyes of the vehicle driver on the driver's seat. Thus, it is possible to eliminate a blind spot due to the pillar, thereby enhancing safety of driving.

A FIFTEENTH EXAMPLE, U.S. Patent Office Publication No. 2009/0143967, Published on Jun. 4, 2009, to Lee teaches a motor vehicle which has a wheel-view camera with a wide-angle lens and an image sensor. The wheel-view camera is mounted in the housing of a side view mirror and points in a downward direction such that the wheel-view camera captures a front wheel. An image processing unit is operatively connected to the wheel-view camera unit for receiving image data from the wheel-view camera. The image processing unit is configured to process the image data such that the image processing unit performs a wide-angle lens correction, an image rotation and a viewpoint conversion. A display unit is operatively connected to the image processing unit. The display unit receives processed image data from the image processing unit and displays an image of the front wheel.

A SIXTEENTH EXAMPLE, U.S. Patent Office Publication No. 2010/0039691, Published on Feb. 18, 2010, to Thomas et al. teaches a vehicular mirror assembly that includes a first bezel for housing an electrochromic glass element and a second bezel for housing a spotter glass element. A spotter glass heating element is positioned behind the spotter glass element for heating the spotter glass above an ambient temperature.

A SEVENTEENTH EXAMPLE, U.S. Patent Office Publication No. 2010/0079881, Published on Apr. 1, 2010, to Lynam et al. teaches a mirror reflective element assembly for an exterior rearview mirror assembly of a vehicle which includes a reflective element and an auxiliary wide angle element. The reflective element has a front surface and a rear surface and a first reflector portion and a second reflector portion, with the first reflector portion having a first reflective coating disposed thereat. The auxiliary wide angle element is disposed at a rear surface of the glass mirror substrate of the reflective element and at the second reflector portion. The auxiliary wide angle element has a glass element having a curved rear surface with a second reflective coating disposed at the curved rear surface. An optical coupling element may be disposed between a front surface of the auxiliary wide angle element and the rear surface of the reflective element, the optical coupling element may be a substantially optically clear and flexible elastomer.

It is apparent now that numerous innovations for wide range mirrors have been provided in the prior art that are adequate for various purposes. Furthermore, even though these innovations may be suitable for the specific individual purposes to which they address, accordingly, they would not be suitable for the purposes of the present invention as heretofore described.

### SUMMARY OF THE INVENTION

AN OBJECT of the present invention is to provide a true safe mirror for a motor vehicle that avoids the disadvantages of the prior art.

ANOTHER OBJECT of the present invention is to provide a true safe mirror for a motor vehicle that is simple and inexpensive to manufacture.

STILL ANOTHER OBJECT of the present invention is to provide a true safe mirror for a motor vehicle that is simple to use.

BRIEFLY STATED, STILL YET ANOTHER OBJECT of the present invention is to provide a first embodiment of the present invention is a true safe mirror for a motor vehicle comprises a wedge shaped member having a front reflective surface. A mechanism on a rear surface of the wedge shaped member is for securing the wedge shaped member on a front reflective surface of an existing mirror of the motor vehicle. The front reflective surface of the wedge shaped member is positioned at a slight angle away from the front reflective surface of the existing mirror, to help increase the vision of a driver of the motor vehicle to eliminate blind spots. A second embodiment comprises a plate shaped member having a front reflective surface. The plate shaped member is encased within a housing carried by the motor vehicle. The plate shaped member has a first portion bent outwardly at a slight angle with respect to a second portion of the plate shaped member to help increase the vision of the driver of the motor vehicle to eliminate blind spots. A third embodiment of the present invention comprises a plate shaped member having a front reflective surface. The plate shaped member is encased within a housing carried by the motor vehicle. The plate shaped member has a first portion bent outwardly at a slight angle with respect to a second portion of the plate shaped member and a third portion bent outwardly at a slight angle with respect to the second portion of the plate shaped member to help increase the vision of the driver of the motor vehicle to eliminate blind spots.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawings are briefly described as follows:

FIG. 1 is a top view of a first embodiment of the present invention per se;

FIG. 2 is a front view of a side view mirror of a motor vehicle showing the first embodiment secured thereto;

FIG. 3 is a cross sectional view taken along line 3-3 in FIG. 2;

FIG. 4 is a front view of a rearview mirror of a motor vehicle showing two of the first embodiments of the present invention secured thereto;

FIG. 5 is a top view taken in the direction of arrow 5 in FIG. 4;

FIG. 6 is a cross sectional view similar to FIG. 3, showing a second embodiment of the present invention as part of a side view mirror;

FIG. 7 is a front view showing a third embodiment of the present invention as part of a rearview mirror; and

FIG. 8 is a top view taken in the direction of arrow 8 in FIG. 7.

### REFERENCE NUMERALS UTILIZED IN THE DRAWING

### First Embodiment

110 true safe mirror
112 motor vehicle
114 wedge shaped member of mirror 110
116 front reflective surface of wedge shaped member 114
118 securing mechanism of mirror 110
120 rear surface of wedge shaped member 114
122 front reflective surface on existing mirror 124
124 existing mirror
126 layer of adhesive material of securing mechanism 118
128 peel-off cover of securing mechanism 118
130 side view mirror for existing mirror 124
132 rearview mirror for existing mirror 124

### Second Embodiment

140 true safe mirror
142 plate shaped member of mirror 140
144 front reflective surface of plate shaped member 142
146 housing on motor vehicle 112
148 first portion of plate shaped member 142
150 second portion of plate shaped member 142
152 side view mirror of motor vehicle 112

### Third Embodiment

160 true safe mirror
162 plate shaped member of mirror 160
164 front reflective surface of plate shaped member 162
166 housing on motor vehicle 112
168 first portion of plate shaped member 162
170 second portion of plate shaped member 162
172 third portion of plate shaped member 162
174 rearview mirror of motor vehicle 112

### DETAILED DESCRIPTION OF THE PREFERRED EMBODIMENT

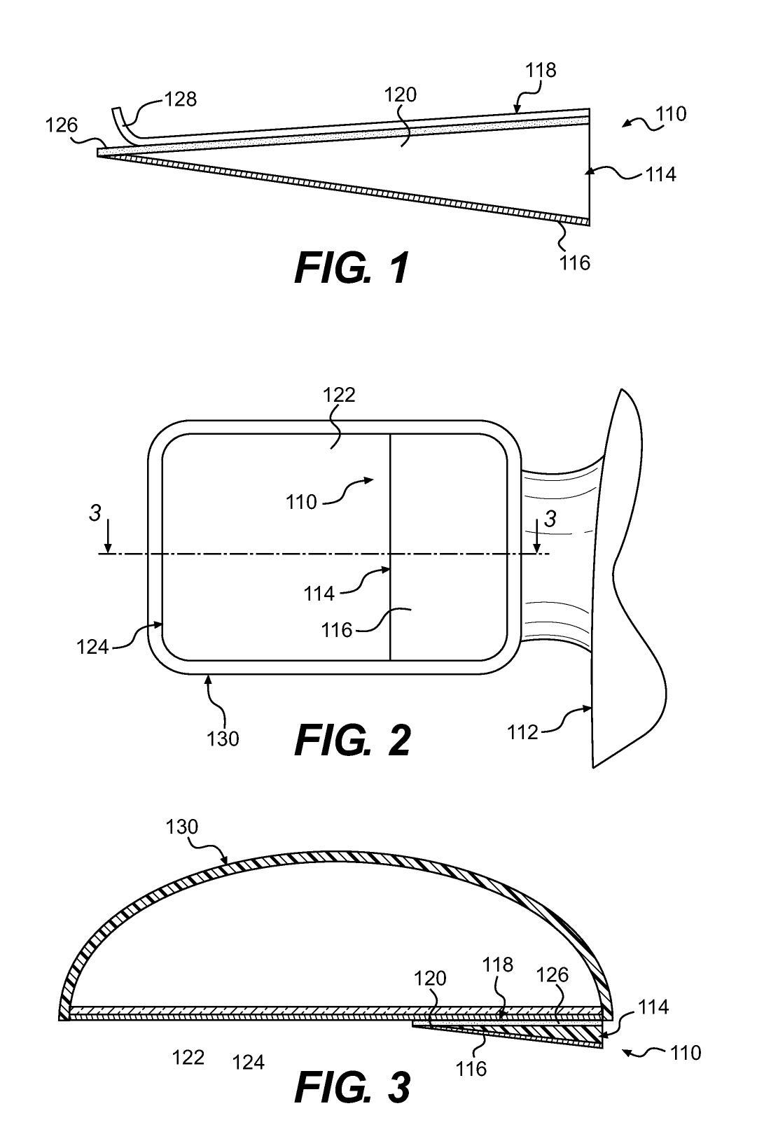

Referring now to the figures, in which like numerals indicate like parts, and particularly to FIGS. 1 through 8, and as such, will be discussed with reference thereto.

A first embodiment of the present invention, as shown in FIGS. 1 through 5, is a true safe mirror 110 for a motor vehicle 112 which comprises a wedge shaped member 114 having a front reflective surface 116. A mechanism 118 on a rear surface 120 of the wedge shaped member 114 is for securing the wedge shaped member 114 on a front reflective surface 122 of an existing mirror 124 of the motor vehicle 112. The front reflective surface 116 of the wedge shaped member 114 is positioned at a slight angle away from the front reflective surface 122 of the existing mirror 124 to help increase the vision of a driver of the motor vehicle 112 to eliminate blind spots. The height of the wedge shaped member 114 is the same as the height of the existing mirror 124.

The securing mechanism 118 comprises a layer of adhesive material 126 applied onto the rear surface 120 of the wedge shaped member 114. The rear surface 120 of the wedge shaped member 114 has tiny grooves being filled with adhesive material 126. The tiny grooves are being used for stronger adhesion. A peel-off cover 128 is placed onto the layer of adhesive material 126. The front reflective surface 116 of the wedge shaped member 114 is at an angle of approximately two to three degrees away from the front reflective surface 122 of the existing mirror 124 of the motor vehicle 112.

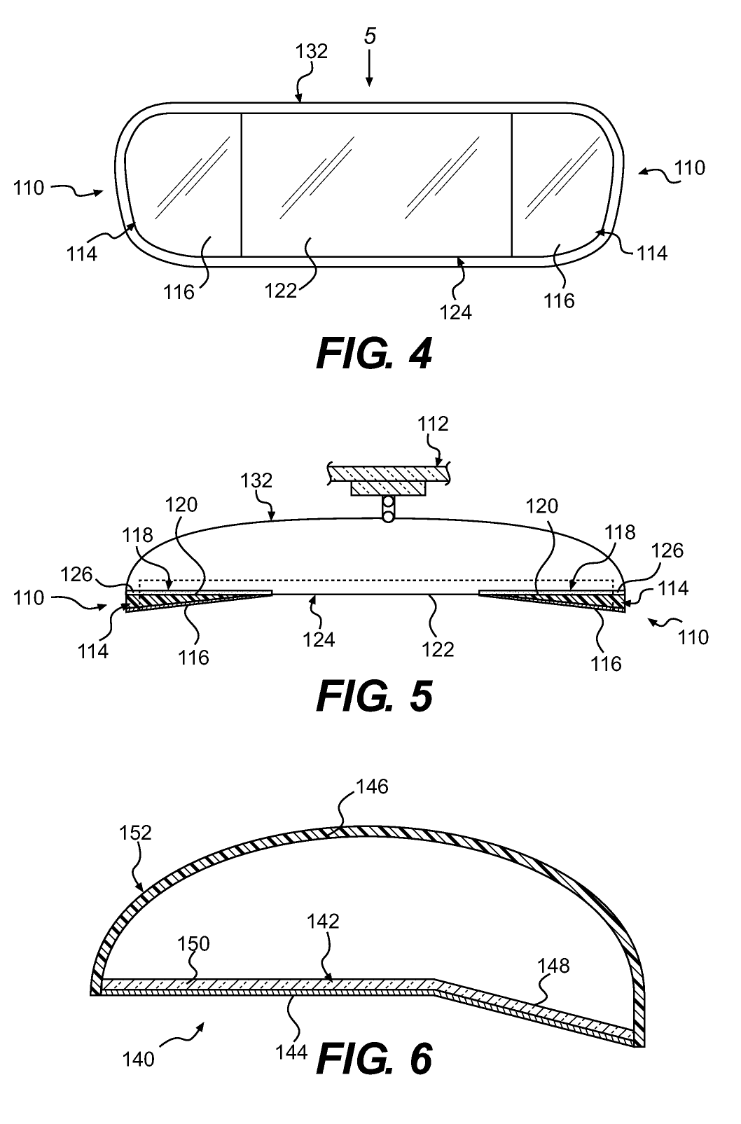

The wedge shaped member 114 is at a length of approximately one third to one half the length of the existing mirror 124 of the motor vehicle 112, when the existing mirror 124 is a side view mirror 130, as in FIGS. 2 and 3. The wedge shaped member 114 is applied onto one side of the side view mirror 130. The wedge shaped member 114 is at a length of approximately one quarter to one third the length of the existing mirror 124 of the motor vehicle 124, when the existing mirror 124 is a rearview mirror 132, as in FIGS. 4 and 5. Two of the wedge shaped members 114 are each applied onto a right side and a left side of the rearview mirror 132.

A second embodiment of the present invention, as shown in FIG. 6, is a true safe mirror 140 for the motor vehicle 112 which comprises a plate shaped member 142 having a front reflective surface 144. The plate shaped member 142 is encased within a housing 146 carried by the motor vehicle 112. The plate shaped member 142 has a first portion 148 bent outwardly at a slight angle with respect to a second portion 150 the motor vehicle 112, to help increase the vision of the driver of the motor vehicle 112 to eliminate blind spots.

The first portion 148 of the plate shaped member 142 is bent at an angle of approximately two to three degrees from the second portion 150 of the plate shaped member 142. The first portion 144 of the plate shaped member 142 is at a length of approximately one third to one half the length of the second portion 150 of the plate shaped member 142, when the plate shaped member 142 is part of a side view mirror 152.

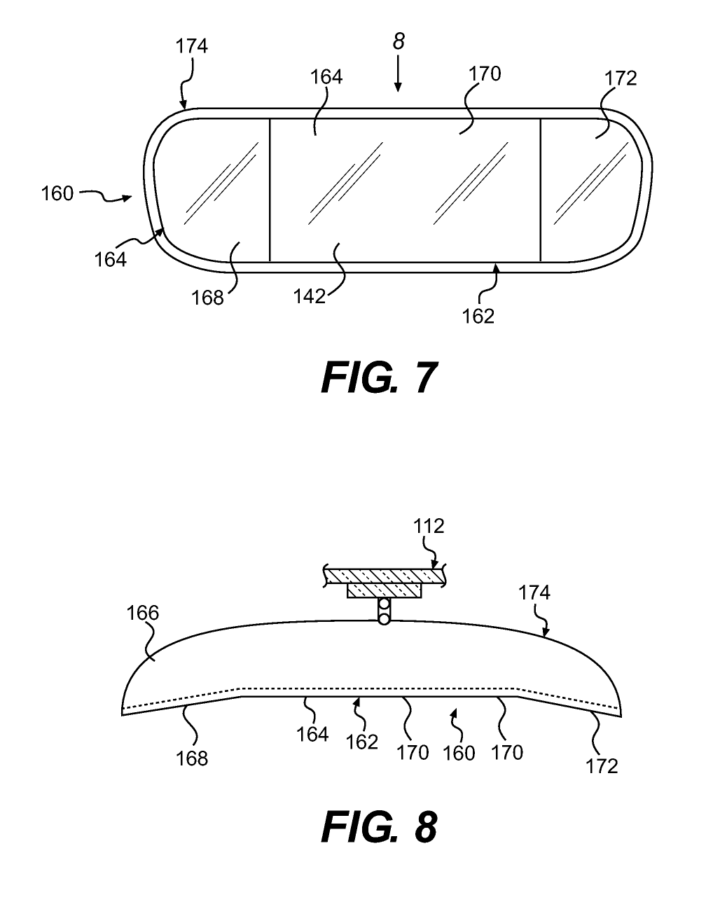

A third embodiment of the present invention, as shown in FIGS. 7 and 8, is a true safe mirror 160 for the motor vehicle 112 which comprises a plate shaped member 162 having a front reflective surface 164. The plate shaped member 162 is encased within a housing 166 carried by the motor vehicle 112. The plate shaped member 162 has a first portion 168 bent outwardly at a slight angle with respect to a second portion 170 of the plate shaped member 162 and a third portion 172 bent outwardly at a slight angle with respect to the second portion 170 of the plate shaped member 162 to help increase the vision of the driver of the motor vehicle 112 to eliminate blind spots.

The first portion 168 and the third portion 172 of the plate shaped member 162 are each bent at an angle of approximately two to three degrees from the second portion 170 of the plate shaped member 162. The first portion 168 and the third portion 172 of the plate shaped member 162 are each at a length of approximately one third to one half the length of the second portion 170 of the plate shaped member 162, when the plate shaped member 162 is part of a rearview mirror 174.

The true safe mirrors 110, 140 and 160 can be assembled similar in the way traditional vehicle mirrors are made, except these mirrors will have a small two to three degree angle to eliminate blind spots. The degree to which the mirrors 110, 140 and 160 are configured may vary. The materials used would be identical to standard mirrors. The angle will also eliminate the occurrence of objects appearing to be far away, when in reality they are much closer. The present invention may be adapted to fit the current needs of the motor vehicle 112 and can be adhered to the existing mirror. It may also be manufactured on new models. The true safe mirrors 110 and 140 can be used for side view mirrors 130, 152 on both the driver and passenger sides of the motor vehicle 112. The true safe mirrors 110 and 160 may be also be used for the rearview mirrors 132 and 174, which would allow the driver to see directly behind the motor vehicle 112 to avoid backing into objects or people.

It will be understood that each of the elements described above, or two or more together, may also find a useful application in other types of constructions differing from the types described above.

While the invention has been illustrated and described as embodiments of a true safe mirror for a motor vehicle, accordingly it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. A true safe mirror for a motor vehicle which comprises:
a) a wedge shaped member having a front reflective surface;
b) means, on tiny grooves of a rear surface of the wedge shaped member, for securing the wedge shaped member on a front reflective surface of an existing mirror of the motor vehicle, whereby the front reflective surface of the wedge shaped member is positioned at a slight angle away from the front reflective surface of the existing mirror to help increase the vision of a driver of the motor vehicle, provide non-distorted image of other nearby vehicle and eliminate blind spots;
c) wherein the tiny grooves of the rear surface of the wedge shaped member are being used for stronger adhesion between the wedge shaped member with the existing mirror and
d) wherein the height of the wedge shaped member is the same as the height of the existing mirror.

2. The true safe mirror as recited in claim 1, wherein the securing means comprises:
a) a layer of adhesive material applied onto the tiny grooves of rear surface of the wedge shaped member; and
b) a peel-off cover placed onto the layer of adhesive material.

3. The true safe mirror as recited in claim 1, wherein the front reflective surface of the wedge shaped member is at the slight angle of approximately two to three degrees away from the front reflective surface of the existing mirror of the motor vehicle.

4. The true safe mirror as recited in claim 1, wherein the wedge shaped member is at a width of approximately one third to one half the length of the existing mirror of the motor vehicle, when the existing mirror is a side view mirror and the wedge shaped member is applied onto one side of the side view mirror.

5. The true safe mirror as recited in claim 1, wherein the wedge shaped member is at a width of approximately one quarter to one third the length of the existing mirror of the motor vehicle, when the existing mirror is a rearview mirror and two of the wedge shaped members are each applied onto a rightmost side and a leftmost side of the rearview mirror.

6. A true safe mirror for a motor vehicle which comprises a plate shaped member having a front reflective surface, wherein the plate shaped member is encased within a housing carried by the motor vehicle, the plate shaped member having a first portion bent at a slight angle with respect to a second portion of the plate shaped member to help increase the vision of a driver of the motor vehicle and eliminate a blind spot.

7. The true safe mirror as recited in claim 6, wherein the first portion of the plate shaped member is bent at an angle of approximately two to three degrees from the second portion of the plate shaped member.

8. The true safe mirror as recited in claim 7, wherein the first portion of the plate shaped member is at a length of approximately one third to one half the length of the second portion of the plate shaped member, when the plate shaped member is part of a side view mirror.

9. A true safe mirror for a motor vehicle which comprises a plate shaped member having a front reflective surface, wherein the plate shaped member is encased within a housing carried by the motor vehicle, the plate shaped member having a first portion bent at a slight angle with respect to a second portion of the plate shaped member and a third portion bent at a slight angle with respect to the second portion of the plate shaped member to help increase the vision of a driver of the motor vehicle and eliminate blind spots.

10. The true safe mirror as recited in claim 9, wherein the first portion and the third portion of the plate shaped member are each bent at an angle of approximately two to three degrees from the second portion of the plate shaped member.

11. The true safe mirror as recited in claim 10, wherein the first portion and the third portion of the plate shaped member are each at a length of approximately one third to one half the length of the second portion of the plate shaped member, when the plate shaped member is part of a rear view mirror.
